(19) United States
(12) Patent Application Publication
(10) Pub. No.: US 2014/0331564 A1
(43) Pub. Date: Nov. 13, 2014

(54) Door Assembly

(71) Applicant: IDEAL SANITARY WARE CO., LTD, Foshan (CN)

(72) Inventor: Wuxiang Wei, Foshan (CN)

(73) Assignee: IDEAL SANITARY WARE CO., LTD, Foshan (CN)

(21) Appl. No.: 13/917,954

(22) Filed: Jun. 14, 2013

(30) Foreign Application Priority Data
May 13, 2013 (CN) 201320256608.1

(51) Int. Cl. E06B 3/964; E06B 5/00

(52) U.S. Cl. CPC E06B 3/964; E06B 5/00
USPC 49/505

(57) ABSTRACT

A door assembly is disclosed which comprises a stationary frame, a movable frame substantively perpendicular to the stationary frame, and an adjusting element fixed to the stationary frame. The movable frame comprises a bottom wall and two side walls extending from the bottom wall, each of the side walls being provided with a protuberance for limiting the adjusting element inside the movable frame. The adjusting element comprises a through hole and a locking element matching the through hole, when the locking element is fixed in the through hole, the locking element acts on the bottom wall and fixes the adjusting element inside the movable frame. The movable frame in the present invention is used as a top frame or a bottom frame in the prior art, such that much materials can be saved.

### CROSS-REFERENCE TO RELATED DOCUMENT

This application claims priority benefit from Chinese utility model application No. 201320256608.1 filed on 13 May 2013 in the name of IDEAL SANITARY WARE CO., LTD, the disclosure of which is incorporated herein by reference in its integrity.

### FIELD OF THE INVENTION

The present invention relates to a door assembly, and in particular, to an adjusting assembly used therein for the adjusting of a stationary frame and a movable frame of the door assembly.

### BACKGROUND OF THE INVENTION

Doors, such as shower doors or balcony doors, are often mounted against wall surfaces and the doors thus mounted are kept as vertical as possible. However, the wall surfaces of buildings are often not exactly vertical, for example, titled toward outside/inside by an angle. Therefore, if the doors are mounted completely along the wall surfaces, the doors may not be smoothly opened or closed. In this regard, it is necessary to adjust the distances between the top/bottom end of a door and a wall surface so as to keep the door in a vertical position.

To achieve this adjustment, a door assembly usually comprises a stationary frame to be attached to a wall surface, and a movable frame, a top frame and a bottom frame connected with and surrounding a door panel, such as a glass door panel. The stationary frame is firstly attached to the wall surface and then the movable frame is moved toward the stationary frame, during which the distances between the top and bottom ends of the movable frame can be adjusted, and the stationary frame are such adjusted that the movable frame is in a vertical position, and in turn, the door panel is also in a vertical position. The stationary and movable frames are finally connected to each other by drilling thereon and by using fasteners.

However, in one aspect, the drilling operation requires at least two people to cooperate and is very time-consuming. In another aspect, the drilling may inadvertently cause damages to the surfaces of the frames (generally made of aluminum materials), which is undesirable to consumers. And more importantly, at least two frames are needed in the vertical position, which requires too much material and complicates the assembling.

### SUMMARY OF THE INVENTION

An object of the present invention is to provide a door assembly which comprises only one frame in the vertical position, so as to conserve materials.

Another object of the present invention is to provide a door assembly which can be mounted without drilling.

To achieve the object, a door assembly is provided which comprises a stationary frame, a movable frame substantively perpendicular to the stationary frame, and an adjusting element fixed to the stationary frame. The movable frame comprises a bottom wall and two side walls extending from the bottom wall, each of the side walls being provided with a protuberance for limiting the adjusting element inside the movable frame. The adjusting element comprises a through hole and a locking element matching the through hole. When the locking element is fixed in the through hole, the locking element acts on the bottom wall and fixes the adjusting element inside the movable frame.

The movable frame in the present invention is used as a top frame or a bottom frame in the prior art. The fixing of the adjusting element to the movable frame is achieved by the interaction between the locking element and the bottom wall, and the interaction between the protuberances and the adjusting element. By adjusting the distance between the movable frame and the stationary frame, the distance between the end of the door panel that is connected with the movable frame and the wall surface can be adjusted, so as to keep the door panel in a vertical position.

Thus there is only one frame in the vertical position, such that the movable frame in the prior art in the vertical position can be deleted, which conserve much materials and can still maintain the adjusting function.

Preferably, the movable frame has a U-shaped cross section. The adjusting element can be surrounded by the movable frame with a U-shaped structure and be limited therein by the protuberances.

Preferably, each of the protuberances is disposed at one end of the corresponding side wall, such that the adjusting element can be more strictly surrounded.

Preferably, each of the protuberance is a flange extending along the corresponding side wall. In this case, the movable frame is shaped to be a track and the adjusting element can slide along one end of the track.

Preferably, the through hole is a screw hole, and the locking element is a screw. When the screw is inserted into the screw hole and fixed therein, one end of the screw acts on the bottom wall, while the other end of the screw pushes the adjusting element and makes it act on the protuberances, such that the adjusting element is fixed inside the movable frame. When the screw is released, the adjusting element can slide inside the movable frame.

Preferably, the adjusting element is further provided with a partition extending between the stationary frame and the bottom wall of the movable frame. The partition can be made by flexible material to avoid the friction and scratch between the stationary frame and the bottom wall of the movable frame caused when adjusting.

Preferably, the adjusting element is further provided with an elastic sheet covering the through hole to prevent the deformation of the bottom wall caused by pressure from the locking element. More preferably, the elastic sheet is further provided with a gasket, such as a rubber block, to increase the friction between the bottom wall and the elastic sheet.

Preferably, the adjusting element and the stationary frame are respectively provided with a first linear projection and a first groove. When the adjusting element is fixed to the stationary frame, the first linear projection is inserted into the first groove to prevent the reversing of the adjusting element.

Preferably, the stationary frame has a U-shaped cross section and comprises a second bottom wall and two second side walls extending from the second bottom wall. Each of the second side walls is provided with a second linear projection, and the adjusting element is provided with two second grooves for receiving the second linear projections. The adjusting element and the stationary frame are respectively provided with a third projection and a clamping hole. The adjusting element can be fixed to the stationary frame by the engagement of the second grooves and the second linear projections, and the engagement of the third projection and the clamping hole.

The door assembly of the present invention is preferably a shower door assembly, a balcony door assembly or other sliding doors, more preferably a shower door assembly.

The movable frame in the present invention is used as a top frame or a bottom frame in the prior art, such that only one frame is needed in the vertical position and much materials can be saved. The door assembly provided in the present invention can be assembled without drilling operation, minimizing risk of damage to the frames, and can be assembled by a single person.

### BRIEF DESCRIPTION OF THE DRAWINGS

FIG. 1 shows primary elements of an exemplary door assembly according to one embodiment of the present invention.

FIG. 2A shows an exemplary door assembly in mounting operation.

FIG. 2B shows an exemplary door assembly in adjusting operation.

FIG. 3A shows the detailed structure of an exemplary adjusting element.

FIG. 3B shows the detailed structure of the adjusting element in FIG. 3A viewed from a different direction.

FIG. 4 shows the detailed structure of an exemplary movable frame.

FIG. 5 shows an adjusting element and a stationary frame in an exemplary mounting way.

FIG. 6 shows an adjusting element and a stationary frame in another exemplary mounting way.

Elements that are irrelevant to the spirit of the present invention are omitted for clarity.

### DETAILED DESCRIPTION OF THE INVENTION

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” include any and all combinations of one or more of the associated listed items. It will be further understood that the terms “comprises” “comprising” “includes” and/or “including” when used herein, specify the presence of stated features, integers, steps, operations, elements, and/or components, but do not preclude the presence or addition of one or more other features, integers, steps, operations, elements, components, and/or groups thereof.

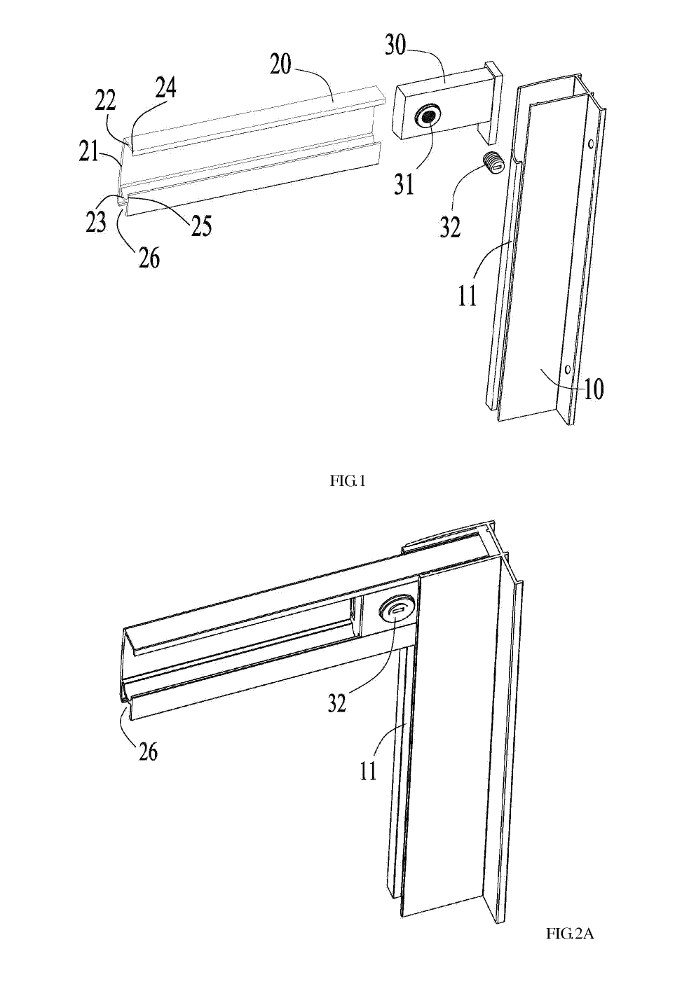

FIG. 1 shows an exemplary door assembly which is a shower door assembly used generally in a bathroom. The shower door assembly comprises a stationary frame 10, a movable frame 20 and an adjusting element 30.

The stationary frame 10 can be attached to a wall surface, for example, by the engagement of a screw and a screw hole. In the example in FIG. 1, the stationary frame 10 is provided with a groove 11 for receiving a door panel.

The movable frame 20 is perpendicular to the stationary frame 10, and is used for fixing and moving the door panel. In the example in FIG. 1, the movable frame 20 is provided with a groove 21 for receiving and fixing one end of the door panel. Two movable frames can be used to clamp the top and bottom ends of the door panel respectively. By adjusting the distance between the movable frame 20 and the stationary frame 10, the distance between one end of the door panel and the wall surface can be adjusted, so as to keep the door panel in a vertical position.

In the example in FIG. 1, the door panel is clamped by the grooves provided in the movable frame 20 and the stationary frame 10. It can be contemplated that the door panel can be connected to the frames through other methods known in the art, for example, various kinds of clamping structures.

The adjusting element 30 is fixed to the stationary frame 10 and comprises a through hole 31 and a locking element 32 matching the through hole. The movable frame 20 comprises a bottom wall 21 and two side walls 22, 23 extending from the bottom wall. The side walls 22, 23 are respectively provided with a protuberance 24/25 for limiting the adjusting element 30 inside the movable frame 20. The bottom wall 21, the side walls 22, 23 and the protuberances 24, 25 together forms a U-shaped structure that can receive and limit the adjusting element 30.

During assembly, the adjusting element 30 is first fixed to the stationary frame 10, and then the adjusting element 30 is inserted into one end of the movable frame 20 with the adjusting element 30 received in the U-shaped structure. After that, the locking element 32 is inserted into the through hole 31 and locked therein. One end of the locking element 32 acts on the bottom wall 21, while the other end of the locking element 32 pushes the adjusting element 30 and makes it act on the protuberances 24, 25, such that the adjusting element 30 is fixed inside the movable frame 20 and the relative position of the movable frame 20 and the stationary frame 10 is fixed.

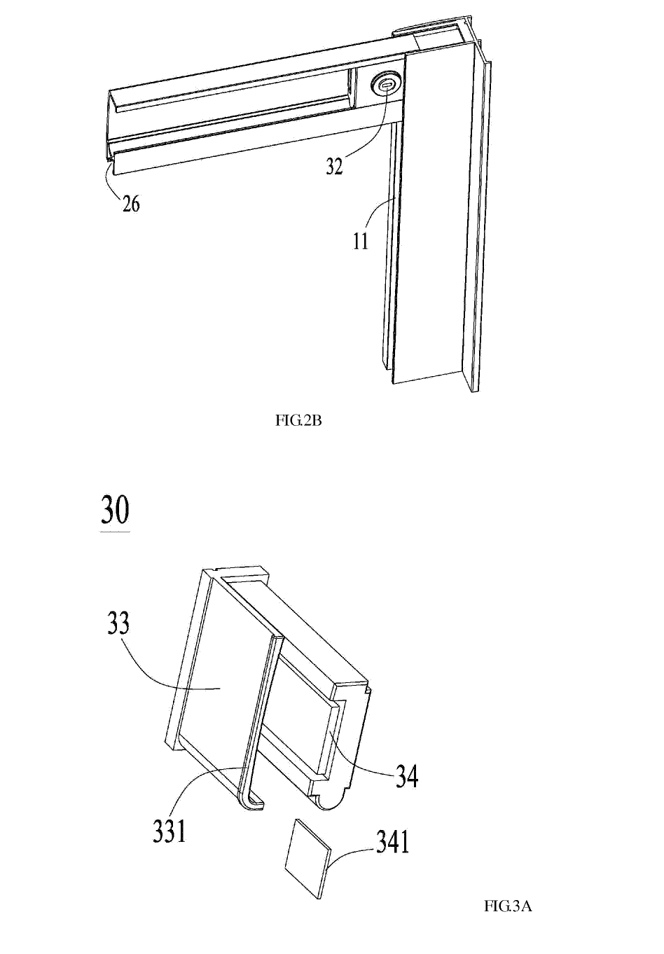

FIG. 2A shows an exemplary door assembly that is mounted. The locking element 32 fixes the position of the movable frame, and the door panel is clamped between the grooves 26, 11. Referring to FIG. 2B, in order to move one end of the door panel, the locking element 32 is released. The movable frame that is connected with the end of the door panel is moved to a proper position. And the locking element 32 is locked up again, such that the movable frame is fixed to a new position.

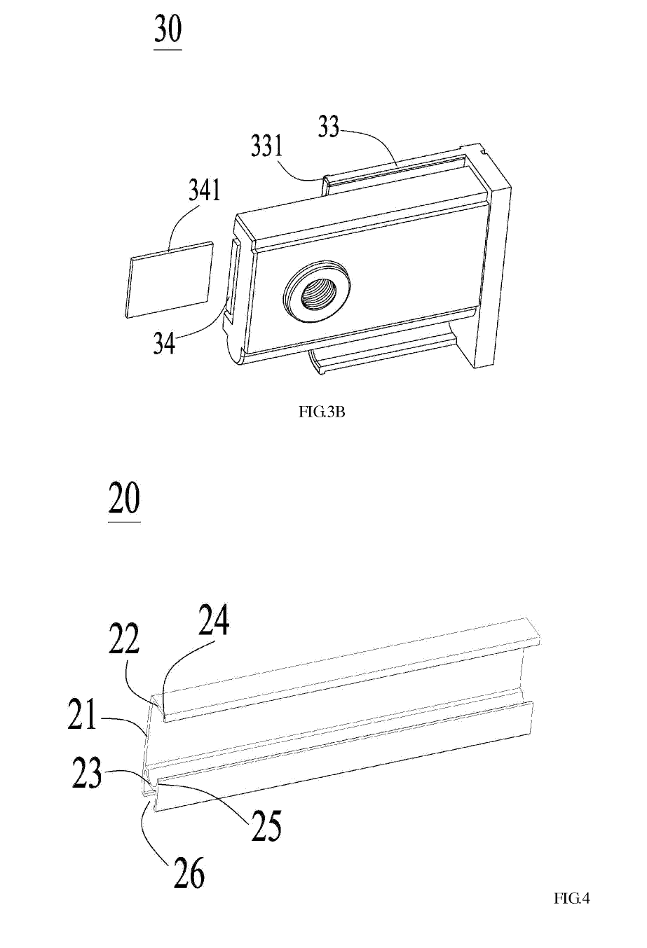

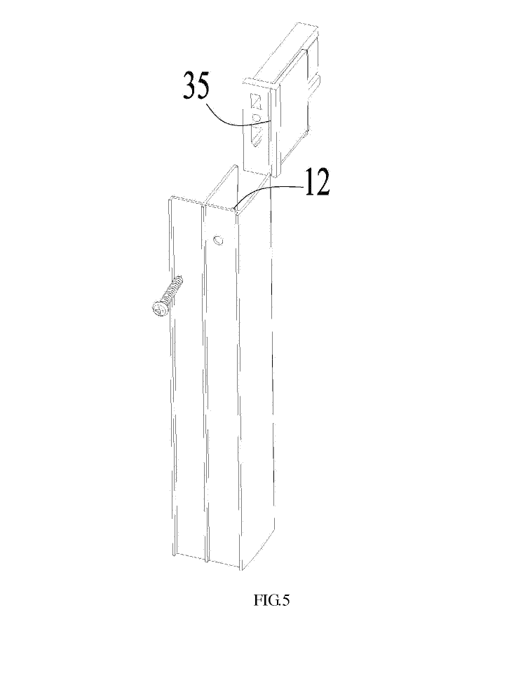

FIGS. 3A and 3B show the detailed structure of an exemplary adjusting element 30 provided with a partition 33. During assembly, the partition 33 is inserted between the stationary frame and the bottom wall, to prevent the friction and scratch between them when adjusting. One end of the partition 33 can further extend towards inside, to surround the adjusting element by one side.

Optionally, the end of the partition 33 is further provided with a flange 331 extending towards outside. As can be seen more clearly in FIGS. 2A and 2B, when the assembly is assembled, the flange 331 would cover one end of one side of the stationary frame, hiding the unflatness of one side of the stationary frame caused when machining an opening for the adjusting element.

In the example in FIGS. 3A and 3B, the adjusting element 30 is further provided with an elastic sheet 34 covering the through hole, so as to prevent the deformation of the bottom wall caused by pressure from the locking element. Further, the elastic sheet 34 is provided with a gasket 341, such as a rubber block, to increase the friction between the bottom wall and the elastic sheet 34.

Although the adjusting element 30 in FIGS. 3A and 3B simultaneously comprises the partition 33, the flange 331, the elastic sheet 34 and the gasket 341, it can be contemplated that the adjusting element 30 can comprise one or more of the partition 33, the flange 331, the elastic sheet 34 and the gasket 341.

FIG. 4 shows the detailed structure of an exemplary movable frame 20. The movable frame 20 comprises a bottom wall 21 and two side walls 22, 23 provided with two protuberances 24, 25 limiting the adjusting element inside the U-shaped structure. One side wall 23 forms a part of the groove for receiving the door panel.

In the example in FIG. 4, the protuberances 24, 25 are both flanges extending along the corresponding side walls. The movable frame 20 is shaped to be a track wherein the adjusting element can slide along one end of the track. Of course, the protuberances can be in other shapes, and many continuing or discontinuing protuberances can be formed, provided that they can limit the adjusting element inside the movable frame.

In the Figures, the through whole 31 is a screw hole, and the locking element 32 is a screw. It can be contemplated that the locking element can be in many other forms, provided that the locking element can act on the bottom wall and at the same time making the adjusting element act on the protuberances.

FIG. 5 shows an exemplary mounting way of the adjusting element 30 to the stationary frame 10. In this example, the adjusting element 30 is fixed to the stationary frame 10 by a fastener (such as a screw) passing through two holes respectively disposed on the adjusting element and the stationary frame. The adjusting element 30 is provided with a first groove 35, while the stationary frame 10 is provided with a first linear projection 12 (only one end is shown). The first linear projection 12 is inserted into the first groove 35 to prevent the reversing of the adjusting element 30.

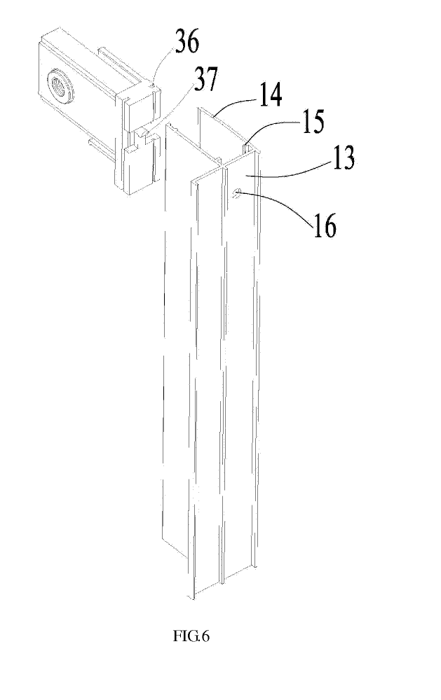

FIG. 6 shows another exemplary mounting way of the adjusting element 30 to the stationary frame 10. The stationary frame 10 has a U-shaped cross section and comprises a second bottom wall 13 and two second side walls 14 extending from the second bottom wall. Each of the second side walls 14 is provided with a second linear projection 15, and the adjusting element 30 is provided with two second grooves 36 for receiving the second linear projections 15. The adjusting element 30 is provided with a third projection 37, and the second bottom wall 13 is provided with a clamping hole 16. After the second linear projections 15 slides into the second grooves 36, the third projection 37 is inserted into the clamping hole 16, so as to fix the adjusting element 30 to the stationary 10, without using any screws.

It should be understood that various example embodiments have been described with reference to the accompanying drawings in which only some example embodiments are shown. The present invention, however, may be embodied in many alternate forms and should not be construed as limited to only the example embodiments set forth herein.

What is claimed is:

1. A door assembly, comprising
a stationary frame,
a movable frame substantively perpendicular to the stationary frame, and
an adjusting element fixed to the stationary frame, wherein
the movable frame comprises a bottom wall and two side walls extending from the bottom wall, each of the side walls being provided with a protuberance for limiting the adjusting element inside the movable frame, and
the adjusting element comprises a through hole and a locking element matching the through hole,
when the locking element is fixed in the through hole, the locking element acts on the bottom wall and fixes the adjusting element inside the movable frame.

2. The door assembly of claim 1, wherein the movable frame has a U-shaped cross section.

3. The door assembly of claim 2, wherein each of the protuberances is disposed at one end of the corresponding side wall.

4. The door assembly of claim 3, wherein each of the protuberances is a flange extending along the corresponding side wall.

5. The door assembly of claim 3, wherein the through hole is a screw hole, and the locking element is a screw.

6. The door assembly of claim 1, wherein the adjusting element is further provided with a partition extending between the stationary frame and the bottom wall of the movable frame.

7. The door assembly of claim 1, wherein the adjusting element is further provided with an elastic sheet covering the through hole.

8. The door assembly of claim 1, wherein the adjusting element and the stationary frame are respectively provided with a first linear projection and a first groove, wherein when the adjusting element is fixed to the stationary frame, the first linear projection is inserted into the first groove.

9. The door assembly of claim 1, wherein the stationary frame has a U-shaped cross section and comprises a second bottom wall and two second side walls extending from the second bottom wall,
each of the second side walls is provided with a second linear projection, and the adjusting element is provided with two second grooves for receiving the second linear projections, and
the adjusting element and the stationary frame are respectively provided with a third projection and a clamping hole.

10. The door assembly of claim 1, wherein the door assembly is a shower door assembly or a balcony door assembly.
